(19) United States
(12) Patent Application Publication
(10) Pub. No.: US 2024/0011832 A1
(43) Pub. Date: Jan. 11, 2024

(54) SPATIAL SPECTROMETER

(71) Applicant: Shphotonics Ltd, Suzhou (CN)

(72) Inventors: Lei SUN, Suzhou (CN); Bing QIU, Suzhou (CN)

(21) Appl. No.: 18/347,908

(22) Filed: Jul. 6, 2023

(30) Foreign Application Priority Data
Jul. 7, 2022 (CN) 202210793918.0

(51) Int. Cl. G01J 3/28; G01J 3/02; G02B 1/00; G02B 3/00

(52) U.S. Cl. CPC G01J 3/2823; G01J 3/0208; G01J 3/021; G02B 1/002; G02B 3/0043; G02B 2207/101

(57) ABSTRACT

A metasurface spatial spectrometer includes a beam splitter, a first reflector, a second reflector, and a reception sensor. A reflective surface of the first reflector or the second reflector includes a plurality of sub-wavelength structures with different functions and arranged according to preset positions. The beam splitter is configured to: transmit a first portion of incident light and reflect a second portion of the incident light, transmit a portion of light reflected by the first reflector, and reflect a portion of light reflected by the second reflector. The first reflector is arranged at an angle of 45°, −45°, 135°, or −135° with respect to the beam splitter, and is configured to reflect the second portion of the incident light. The second reflector is arranged perpendicular to the first reflector, and is configured to reflect the first portion of the incident light.

### CROSS-REFERENCE TO RELATED APPLICATION

This application claims priority to Chinese Application No. 202210793918.0, filed on Jul. 7, 2022, the entire content of which is incorporated herein by reference.

### TECHNICAL FIELD

The present disclosure relates to the technical field of optics and, in particular, to a metasurface spatial spectrometer (also simply referred to as “metasurface spectrometer”).

### BACKGROUND

Fourier transform spectrometer is commonly used in infrared spectrum analysis and mainly includes a Michelson interferometer and a computer. The main function of the Michelson interferometer is to divide light emitted from a light source into two beams to create a certain optical path difference, and then to combine them to produce interference. The obtained interferogram function includes all frequency and intensity information of the light source. The computer is used to perform Fourier transform on the interferogram function to calculate distribution of intensities of the light source versus frequencies. A time-modulated Fourier transform spectrometer can quickly obtain the results of spectral analysis, but the moving parts in it could easily cause some instability.

A spatially modulated Fourier transform spectrometer uses fixed components and combines a tilted plane mirror with a beam splitter to achieve spatial modulation of interference images. However, the spatially modulated Fourier transform spectrometer is bulky, and its spectral resolution is limited by the pixel size of a detector. Another spectrometer is a multi-channel spectrometer based on step-shaped and wedge-shaped Fabry-Perot interference. The multi-channel spectrometer facilitates spatial sampling of the optical path difference. But due to wavelength selectivity of each channel in the multi-channel spectrometer, only single-wavelength or narrow-bandwidth spectral range measurements can be performed. As such, existing spatially modulated Fourier transform spectrometers have various problems including poor resolution, limited light wavelength processing range, or bulky dimension.

### SUMMARY

One aspect of the present disclosure provides a metasurface spatial spectrometer. The metasurface spatial spectrometer includes a first beam splitter, a first reflector, a second reflector, and a reception sensor. A reflective surface of the first reflector or the second reflector includes a plurality of sub-wavelength structures with different functions and arranged according to preset positions. The beam splitter is configured to: transmit a first portion of incident light and reflect a second portion of the incident light, transmit a portion of light reflected by the first reflector, and reflect a portion of light reflected by the second reflector. The first reflector is arranged at an angle of 45°, −45°, 135°, or −135° with respect to the beam splitter, and is configured to reflect the second portion of the incident light. The second reflector is arranged perpendicular to the first reflector, and is configured to reflect the first portion of the incident light. The reception sensor is configured to receive the portion of the light reflected by the first reflector and transmitted by the beam splitter and the portion of the light reflected by the second reflector and reflected by the beam splitter to form interference.

### BRIEF DESCRIPTION OF THE DRAWINGS

To more clearly illustrate the technical solutions in the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts and may be encompassed in the present disclosure.

FIG. 1 is a schematic structural diagram of an exemplary metasurface spatial spectrometer according to some embodiments of the present disclosure.

FIG. 2 is a schematic structural diagram of another exemplary metasurface spatial spectrometer according to some embodiments of the present disclosure.

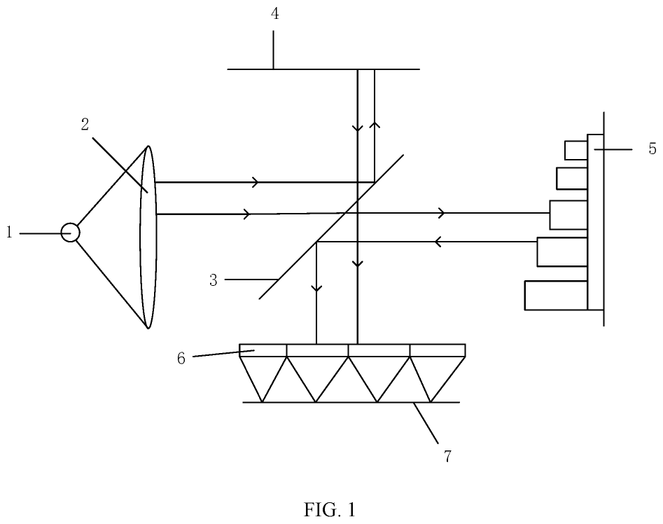

Components indicated by numerals in FIG. 1 include: 1. light source, 2. lens, 3, first beam splitter, 4. first reflector, 5. second reflector, 6. metasurface lens array, and 7. reception sensor.

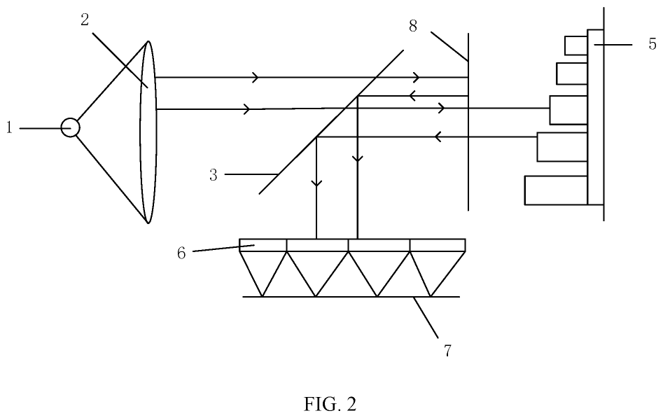

Components indicated by numerals in FIG. 2 include: 1. light source, 2. lens, 3, first beam splitter, 5. second reflector, 6. metasurface lens array, 7. reception sensor, and 8. second beam splitter.

### DETAILED DESCRIPTION OF THE EMBODIMENTS

In the following, some example embodiments are described. As those skilled in the art would recognize, the described embodiments can be modified in various different manners, all without departing from the spirit or scope of the present disclosure. Accordingly, the drawings and descriptions are illustrative in nature and not limiting.

In the present disclosure, terms such as “first,” “second,” and “third” can be used to describe various elements, components, regions, layers, and/or parts. However, these elements, components, regions, layers, and/or parts should not be limited by these terms. These terms are only used to distinguish one element, component, region, layer, or part from another element, component, region, layer, or layer. Therefore, a first element, component, region, layer, or part discussed below can also be referred to as a second element, component, region, layer, or part, which does not constitute a departure from the teachings of the present disclosure. For example, the terms “first,” “second,” etc. may be used in the following embodiments to describe beam splitters. But the beam splitters should not be limited to these terms. These terms are only used to distinguish different beam splitters. In the following embodiments, the terms “first,” “second,” etc. may be used to describe other objects of a same type, which are not repeated herein.

A term specifying a relative spatial relationship, such as “below,” “beneath,” “lower,” “under,” “above,” or “higher,” can be used in the disclosure to describe the relationship of one or more elements or features relative to other one or more elements or features as illustrated in the drawings. These relative spatial terms are intended to also encompass different orientations of the device in use or operation in addition to the orientation shown in the drawings. For example, if the device in a drawing is turned over, an element described as “beneath,” “below,” or “under” another element or feature would then be “above” the other element or feature. Therefore, an example term such as “beneath” or “under” can encompass both above and below. Further, a term such as “before,” “in front of,” “after,” or “subsequently” can similarly be used, for example, to indicate the order in which light passes through the elements. A device can be oriented otherwise (e.g., being rotated by 90 degrees or being at another orientation) while the relative spatial terms used herein still apply. In addition, when a layer is referred to as being “between” two layers, it can be the only layer between the two layers, or there can be one or more intervening layers.

Terminology used in the disclosure is for the purpose of describing the embodiments only and is not intended to limit the present disclosure. As used herein, the terms “a,” “an,” and “the” in the singular form are intended to also include the plural form, unless the context clearly indicates otherwise. Terms such as “comprising” and/or “including” specify the presence of stated features, entities, steps, operations, elements, and/or parts, but do not exclude the existence or addition of one or more other features, integers, steps, operations, elements, parts, and/or combinations thereof. As used herein, the term “and/or” includes any and all combinations of one or more of the listed items. The phrases “at least one of A and B” and “at least one of A or B” mean only A, only B, or both A and B.

When an element or layer is referred to as being “on,” “connected to,” “coupled to,” or “adjacent to” another element or layer, the element or layer can be directly on, directly connected to, directly coupled to, or directly adjacent to the other element or layer, or there can be one or more intervening elements or layers. In contrast, when an element or layer is referred to as being “directly on,” “directly connected to,” “directly coupled to,” or “directly adjacent to” another element or layer, then there is no intervening element or layer. “On” or “directly on” should not be interpreted as requiring that one layer completely covers the underlying layer.

In the disclosure, description is made with reference to schematic illustrations of example embodiments (and intermediate structures). As such, changes of the illustrated shapes, for example, as a result of fabrication techniques and/or tolerances, can be expected. Thus, embodiments of the present disclosure should not be interpreted as being limited to the specific shapes of regions illustrated in the drawings, but are to include deviations in shapes that result, for example, from fabrication. Therefore, the regions illustrated in the drawings are schematic and their shapes are not intended to illustrate the actual shapes of the regions of the device and are not intended to limit the scope of the present disclosure.

Unless otherwise defined, all terms (including technical and scientific terms) used herein have the same meaning as commonly understood by those of ordinary skill in the art to which this disclosure belongs. Terms such as those defined in commonly used dictionaries should be interpreted to have meanings consistent with their meanings in the relevant field and/or in the context of this disclosure, unless expressly defined otherwise herein.

The present disclosure provides a metasurface spatial spectrometer (i.e., a spectrometer using metasurface component(s) and configured to spatially modulate light), which can solve at least the problem of poor resolutions of existing spectrometers.

FIG. 1 is a schematic structural diagram of an exemplary metasurface spatial spectrometer according to some embodiments of the present disclosure. As shown in FIG. 1, the metasurface spatial spectrometer includes a first beam splitter 3, a first reflector 4, a second reflector 5, and a reception sensor 7. A reflective surface of the first reflector 4 or the second reflector 5 includes a plurality of sub-wavelength structures with different light processing functions arranged according to preset positions.

The first beam splitter 3 is configured at an angle of 45° or −45° or 135° or −135° with respect to a transmission direction of incident light of a light source 1. The first beam splitter 3 is configured to transmit a portion of the incident light and to reflect another portion of the incident light. The first beam splitter 3 is also configured to transmit a portion of light reflected by the first reflector 4, and to reflect a portion of light reflected by the second reflector 5.

The first reflector 4 is arranged parallel to the transmission direction of the incident light, and is configured to reflect the portion of the incident light reflected by the first beam splitter 3.

The second reflector 5 is arranged perpendicular to the transmission direction of the incident light, and is configured to reflect the portion of the incident light transmitted by the first beam splitter 3.

The reception sensor 7 is configured to receive the portions of the light transmitted or reflected by the first beam splitter 3 to form interference.

In some embodiments, as shown in FIG. 1, the first beam splitter 3 is configured at an angle of 45° with respect to the transmission direction of the incident light. After passing through a lens 2, the incident light emitted from the light source 1 enters the first beam splitter 3 and is divided into two beams of light. The two beams of light respectively refer to a portion of light reflected by the first beam splitter 3 and another portion of light transmitted by the first beam splitter 3. The first beam splitter 3 reflects a portion of the incident light, and a transmission direction of the reflected beam is perpendicular to the transmission direction of the incident light. The reflected beam reflected by the first beam splitter 3 enters the first reflector 4 and is reflected by the first reflector 4. The reflected beam reflected by the first reflector 4 enters the first beam splitter 3. A portion of the reflected beam reflected by the first reflector 4 passes through the first beam splitter 3, and enters a metasurface lens array 6. After being processed by the metasurface lens array 6, the portion of the reflected beam reflected by the first reflector 4 enters the reception sensor 7.

The other of the two beams of light is the portion of light transmitted by the first beam splitter 3. The transmitted portion of light continues to transmit along the transmission direction of the incident light, and enters the second reflector 5. After being reflected by the second reflector 5, the transmitted portion of light enters the first beam splitter 3. A portion of the transmitted portion of light reflected by the first beam splitter 3 enters the metasurface lens array 6, and continues to enter the reception sensor 7 after being processed by the metasurface lens array 6. The reception sensor 7 receives the two beams of light and combines them to form interference. Different interference results may be obtained due to different phases at different positions in the second reflector 5. Thus, an interferogram function containing frequency and intensity information of the light source 1 is obtained, thereby completing a spectral analysis.

In some embodiments, a metasurface spatial spectrometer is provided. The metasurface spatial spectrometer includes an element of a metasurface reflecting mirror, which effectively reduces a size of the metasurface spatial spectrometer and improves the resolution of the metasurface spatial spectrometer. The two beams of light are reflected by different reflectors to produce different optical paths at different positions, such that combination of the two beams of light with an optical path difference can produce interference to complete the spectral analysis. The metasurface spatial spectrometer becomes smaller and lighter and can be applied in more scenarios.

In some embodiments, the lens 2 is included between the first beam splitter 3 and the light source 1. The lens 2 is configured to expand and collimate the light emitted from the source 1 into parallel light to enter the first beam splitter 3.

In some embodiments, as shown in FIG. 1, the lens 2 is located behind the light source 1 and before the first beam splitter 3. The light emitted from the light source 1 can be expanded into a large beam of parallel light as the incident light to enter a beam splitter, thereby increasing a diameter of the light beam.

In some embodiments, the metasurface spatial spectrometer further includes a second beam splitter 8 disposed between the second reflector 5 and the first beam splitter 3. The second beam splitter 8 is configured to reflect a portion of the incident light transmitted by the first beam splitter 3, and to transmit another portion of the incident light transmitted by the first beam splitter 3. The second beam splitter 8 is also configured to transmit a portion of the light reflected by the second reflector 5.

FIG. 2 is a schematic structural diagram of another exemplary metasurface spatial spectrometer according to some embodiments of the present disclosure. In some embodiments, as shown in FIG. 2, the metasurface spatial spectrometer includes the second beam splitter 8 disposed after the first beam splitter 3 and before the second reflector 5. The second beam splitter 8 is arranged perpendicular to the transmission direction of the incident light. After the portion of the incident light is transmitted by the first beam splitter 3, the transmitted portion of the incident light continues to transmit along the transmission direction of the incident light to enter the second light splitter 8, and is divided into two beams of light by the second beam splitter 8. The two beams of light include a beam of reflected light reflected by the second beam splitter 8 and a beam of transmitted light transmitted by the second beam splitter 8.

The second beam splitter 8 reflects a portion of the incident light transmitted by the first beam splitter 3. The reflected light enters the first beam splitter 3, is reflected by the first beam splitter 3 to enter the metasurface lens array 6, and is processed by the metasurface lens array 6 before entering the reception sensor 7.

The other of the two beams of light is the transmitted light transmitted by the second beam splitter 8. The transmitted light continues to transmit along the transmission direction of the incident light to enter the second reflector 5, and is reflected by the second reflector 5 to enter the second beam splitter 8. The transmitted light transmitted by the second beam splitter 8 continues to enter the first beam splitter 3, is reflected by the first beam splitter 3 to the metasurface lens array 6, and is processed by the metasurface lens array 6 before entering the reception sensor 7.

In some embodiments, the second beam splitter 8 is added, such that the transmitted light transmitted by the first beam splitter 3 can be reflected and transmitted among the first beam splitter 3, the second beam splitter 8, and the second reflector 5. The plurality of sub-wavelength structures on the surface of the second reflector 5 are able to perform various light processing functions, e.g., changing phase, chromatic aberration, amplitude, and/or frequency, etc. of the light, such that light reflected by the second reflector 5 and light reflected by the second beam splitter 8 have different phases at different positions. Thus, the reception sensor 7 receives and combines multiple beams of light to obtain different interference results.

In some embodiments, the second reflector 5 is also configured to reflect the light transmitted by the second beam splitter 8.

In some embodiments, the first beam splitter 3 is also configured to reflect a portion of the light transmitted or reflected by the second beam splitter 8.

In some embodiments, as shown in FIG. 2, with the second beam splitter 8 being provided, the portion of the incident light transmitted by the first beam splitter 3 enters the second beam splitter 8. The second beam splitter 8 reflects a portion of the incident light and transmits another portion of the incident light, such that the portion of the incident light transmitted by the second beam splitter 8 enters the second reflector 5 and is reflected by the second reflector 5, and the portion of the light reflected by the second beam splitter 8 enters the first beam splitter 3 and is reflected by the first beam splitter 3.

In some embodiments, the plurality of sub-wavelength structures having different light processing functions include at least two types of materials, and the plurality of sub-wavelength structures perform different light processing functions.

In some embodiments, the reflective surface of the second reflector 5 includes the plurality of sub-wavelength structures arranged according to preset positions. The plurality of sub-wavelength structures can be in the form of sub-wavelength pillars. At least two types of materials are included among the plurality of sub-wavelength pillars. Different materials support different light processing functions, such that different sub-wavelength pillars provide different light processing functions. In some other embodiments, the reflective surface of the first reflector 4 may also include a plurality of sub-wavelength structures, which is not limited by the present disclosure.

In some embodiments, the light processing functions of the plurality of sub-wavelength structures include changing at least one of phase, chromatic aberration, polarization, amplitude, or frequency.

In some embodiments, through combination of the plurality of sub-wavelength structures with different materials and arrangement of the plurality of sub-wavelength structures, etc., different light processing functions can be performed, including but not limited to changing phase, chromatic aberration, polarization, amplitude, and/or frequency. Other light processing functions may also be achieved through different arrangements and combinations of the plurality of sub-wavelength structures, which is not limited by the present disclosure.

In some embodiments, the plurality of sub-wavelength structures include a plurality of sub-wavelength structural units. Each sub-wavelength structural unit includes sub-wavelength structures that are same as each other (i.e., of a same type). Sub-wavelength structures in different sub-wavelength structural units are different from each other (i.e., of different types). The plurality of sub-wavelength structural units are arranged according to preset positions.

In some embodiments, the plurality of sub-wavelength structures on the reflective surface of the second reflector 5 are divided into multiple sub-wavelength structural units. Sub-wavelength pillars having same sub-wavelength structures are grouped into one sub-wavelength structural unit. Sub-wavelength pillars having different sub-wavelength structures are grouped into different sub-wavelength structural units, and are arranged according to preset positions. For example, the sub-wavelength pillars having different sub-wavelength structures may be arranged according to heights of the sub-wavelength pillars from low to high, or according to sizes of the sub-wavelength pillars from large to small, or randomly arranged. The sub-wavelength pillars having different sub-wavelength structures may also be arranged according to different materials, and sub-wavelength pillars of corresponding materials may be configured at corresponding positions to achieve preset optical functions. In addition, the sizes of the sub-wavelength structural units are in the sub-wavelength order, which improves the resolution and the light processing range of the metasurface spatial spectrometer. The metasurface spatial spectrometer provided in the embodiments of the present disclosure is only exemplary, and does not constitute a limitation to the present disclosure.

In some embodiments, the metasurface spatial spectrometer further includes the metasurface lens array 6 disposed between the reception sensor 7 and the first beam splitter 3 for receiving the light transmitted or reflected by the first beam splitter 3 and emitting to the reception sensor 7. Each metasurface lens in the metasurface lens array 6 refers to a lens including one or more sub-wavelength pillars with same or different structures and same or different light processing functions.

In some embodiments, the metasurface spatial spectrometer further includes the metasurface lens array 6 disposed after the first beam splitter 3 and before the reception sensor 7. The metasurface lens array 6 includes at least one metasurface lens. Each metasurface lens includes a plurality of sub-wavelength pillars disposed at its surface. The materials, structures and/or arrangements of the plurality of sub-wavelength pillars are set according to preset configurations. Sub-wavelength pillars having different structures and/or materials are configured, and positions of the sub-wavelength pillars are determined, according to different optical functions. The metasurface lens array 6 receives all the light transmitted or reflected by the first beam splitter 3, and emits the processed light to the reception sensor 7.

In the embodiments of the present disclosure, the metasurface spatial spectrometer uses metasurface devices as reflectors and has reduced size, thereby making the corresponding spectrometer system miniaturized and lightweight. In addition, the sizes of the sub-wavelength structural units are in the sub-wavelength order, which improves the resolution and the light processing range of the metasurface spatial spectrometer. As such, through the preset sub-wavelength structure arrangement on the surface of the reflector, the light beams may be processed differently, such that the two beams of light can have differentiated optical paths at different positions, thereby achieving multi-beam interference. The light processing functions of the metasurface devices may include, but are not limited to, beam splitting, focusing, diverging, collimating, polarizing, filtering, deflecting, and/or intensity attenuation.

While various embodiments of the present disclosure have been described, additional changes and modifications to these embodiments may be made by those skilled in the art once the basic inventive concept is appreciated. Therefore, the appended claims are intended to be construed to cover the preferred embodiment and all changes and modifications which fall within the scope of the present disclosure.

The various embodiments have been described above to illustrate the objectives, technical solutions and beneficial effects of the present disclosure in detail. It should be understood that the above description is merely exemplary, and is not intended to limit the scope of the present disclosure. Any modification, equivalent replacement, improvement, etc. made on the basis of the technical solutions of the present disclosure shall be included in the scope of the present disclosure.

What is claimed is:

1. A spatial spectrometer comprising:
a beam splitter;
a first reflector;
a second reflector; and
a reception sensor;
wherein:
a reflective surface of the first reflector or the second reflector includes a plurality of sub-wavelength structures with different functions and arranged according to preset positions;
the beam splitter is configured to:
transmit a first portion of incident light and reflect a second portion of the incident light,
transmit a portion of light reflected by the first reflector, and
reflect a portion of light reflected by the second reflector;
the first reflector is arranged at an angle of 45°, −45°, 135°, or −135° with respect to the beam splitter, and is configured to reflect the second portion of the incident light;
the second reflector is arranged perpendicular to the first reflector, and is configured to reflect the first portion of the incident light; and
the reception sensor is configured to receive the portion of the light reflected by the first reflector and transmitted by the beam splitter and the portion of the light reflected by the second reflector and reflected by the beam splitter to form interference.

2. The spatial spectrometer of claim 1, further comprising:
a lens disposed on a side of the beam splitter opposite to a side on which the second reflector is disposed, and configured to expand and collimate the incident light.

3. The spatial spectrometer of claim 1,
wherein the beam splitter is a first beam splitter;
the spatial spectrometer further comprising:
a second beam splitter disposed between the second reflector and the first beam splitter, and configured to:
reflect a portion of the first portion of the incident light,
transmit another portion of the first portion of the incident light, and
transmit a portion of the light reflected by the second reflector.

4. The spatial spectrometer of claim 3, wherein:
the second reflector is further configured to reflect a portion of the light transmitted by the second beam splitter.

5. The spatial spectrometer of claim 4, wherein:
the first beam splitter is further configured to reflect a portion of the light transmitted or reflected by the second beam splitter.

6. The spatial spectrometer of claim 1, wherein:
the plurality of sub-wavelength structures with different functions include at least two types of materials, and the plurality of sub-wavelength structures are configured to perform different light processing functions.

7. The spatial spectrometer of claim 6, wherein:
each of the light processing functions of the plurality of sub-wavelength structures includes changing at least one of phase, chromatic aberration, polarization, amplitude, or frequency.

8. The spatial spectrometer of claim 7, wherein:
the plurality of sub-wavelength structures are grouped into a plurality of sub-wavelength structural units;
each sub-wavelength structural unit includes sub-wavelength structures of a same type;
different sub-wavelength structural units include sub-wavelength structures of different types; and
the plurality of sub-wavelength structural units are arranged according to preset positions.

9. The spatial spectrometer of claim 1, further comprising:
a metasurface lens array disposed between the reception sensor and the beam splitter, and configured to receive the light transmitted or reflected by the beam splitter and emit received light to the reception sensor; and
the metasurface lens array includes a plurality of metasurface lenses each including a plurality of sub-wavelength pillars, the sub-wavelength pillars in different ones of the plurality of metasurface lens having different structures and different light processing functions.
